(19) United States
(12) Patent Application Publication
(10) Pub. No.: US 2007/0232771 A1
(43) Pub. Date: Oct. 4, 2007

(54) Dispersant for manufacturing vinyl chloride resin and method of manufacturing vinyl chloride resin using the same

(76) Inventors: Yi-Rac Choi, Seo-gu (KR); Kyung-Hyun Kim, Seoul (KR); Seong-Yong Ahn, Jeongeup-si (KR); Min-Ju Yi, Dongnae-gu (KR); Hyun-Kyou Ha, Yeosu-si (KR)

Correspondence Address: CANTOR COLBURN, LLP, 55 GRIFFIN ROAD SOUTH, BLOOMFIELD, CT, 06002, US

(21) Appl. No.: 11/518,088

(22) Filed: Sep. 8, 2006

(30) Foreign Application Priority Data
Mar. 29, 2006 (KR) 10-2006-0028392

(51) Int. Cl. C08F 14/06

(52) U.S. Cl. 526/344; 526/319

(57) ABSTRACT

The present invention relates to a dispersant for manufacturing vinyl chloride resin and a method of manufacturing vinyl chloride resin using the same. More precisely, this invention relates to a dispersant which is prepared by RAFT, harbors a hydrophobic group and one or more hydrophilic groups not containing a hydroxy group, and has a polydispersity index of 1.1-2, and a method of manufacturing vinyl chloride resin using the said dispersant.

The dispersant for manufacturing vinyl chloride resin of the present invention and the manufacturing method of the present invention facilitates the preparation of vinyl chloride resin characterized by even size distribution, excellent sphericity and proper particle diameter.

This application claims the benefit of the filing date of Korean Patent Application No. 10-2006-0028392 filed on Mar. 29, 2006 in the Korean Intellectual Property Office, the disclosure of which is incorporated herein in its entirety by reference.

### TECHNICAL FIELD

The present invention relates to a dispersant for manufacturing vinyl chloride resin and a method of manufacturing vinyl chloride resin using the same. More precisely, the present invention relates to a dispersant for manufacturing vinyl chloride resin which is characterized by even size distribution, excellent sphericity and proper particle diameter and a method of manufacturing vinyl chloride resin using the same.

### BACKGROUND ART

In general, a dispersant is added to the reaction solution when manufacturing a vinyl chloride resin by suspension polymerization, aiming at dispersing various reactants including monomers. At this time, a dispersant has to have properly regulated hydrophilicity/hydrophobicity and regular molecular weight, since these dispersant characteristics significantly affect the particle size, size distribution and the stability of a final vinyl chloride resin product.

A dispersant itself is a polymer. Ion polymerization is a conventional method to produce a polymer having a narrow molecular weight distribution but applicable monomers are limited and reaction conditions are very strict, making this method industrially inapplicable.

So, another attempt has been made to prepare a polymer with a narrow molecular weight distribution, which is living free radical polymerization. The reaction conditions for this method are simple compared with those of ion polymerization, thereby increasing industrial applicability. According to living free radical polymerization, the molecular weight distribution can be regulated easily owing to the quick initiation reaction, and the chain activity is preserved during the polymerization, which is the living property, because the reversible exchange reaction between active species and dormant species is induced continuously. In addition, the selection of a monomer and the polymerization conditions are not strictly limited, enabling the synthesis of such polymers as block copolymers having different structures.

For living free radical polymerization, various reaction methods such as iniferter method, nitroxide method, ATRP (atom transfer radical polymerization) and RAFT (reversible addition-fragmentation chain transfer polymerization) have been proposed.

According to the conventional method for manufacturing vinyl chloride resin, a hydrophobic monomer is polymerized first and then a dispersant with some of the hydroxy groups (—OH) substituted to increase hydrophilicity, or a cellulose dispersant is added thereto. However, such dispersants exhibit a cloud point within the polymerization temperature range, resulting in a precipitate which will decrease the colloid stability. As a result, the properties such as size distribution and sphericity of the final vinyl chloride resin product decrease.

WO 97/08212 describes a polymerization method using a dispersant having a hydrophilic group and a hydrophobic group. However, in this method, a dispersant is simply obtained by solution polymerization, resulting in a dispersant with a wide molecular weight distribution. Such a dispersant with a wide molecular weight distribution also reduces the properties, including granularity, of the final polymer product.

Thus, it has long been the aim to produce a dispersant with regular size distribution, excellent sphericity and proper average particle diameter for use in preparing vinyl chloride resin, but this has not yet been achieved.

### DISCLOSURE OF THE INVENTION

It is an object of the present invention to provide a method of manufacturing vinyl chloride resin which is characterized by even size distribution, excellent sphericity and proper particle diameter.

It is another object of the present invention to provide a dispersant useful for the above manufacturing method.

The above objects of the present invention and other additional objects can be achieved by the exemplary embodiments of the present invention described in detail hereinafter.

To achieve the first object, the present invention provides a method of manufacturing vinyl chloride resin including the step of suspension polymerization after dispersing 100 weight part of vinyl chloride monomer; 0.01-1 weight part of a dispersant harboring a hydrophobic group and one or more hydrophilic groups not containing a hydroxy group and having a polydispersity index of 1.1-2; and 0.01-1 weight part of an initiator in a solvent.

The hydrophilic group is preferably one of C₃-C₇ carboxylic acid, C₂-C₉ sulfonic acid or C₂-C₉ hydroxy group. Particularly, the carboxylic acid is selected from a group consisting of acrylic acid, methacrylic acid, itaconic acid and maleic anhydride. The sulfonic acid can be styrene sulfonic acid. The alcohol used above is hydroxyethylacrylate, hydroxyethylmethacrylate or ethyleneglycolmonovinylether.

The hydrophobic monomer is selected from a group consisting of vinylacetate, ethylacetate, methylacrylate, ethylacrylate, 2-ethylhexylacrylate, butylmethacrylate, butylacrylate, methylmethacrylate and glycidylmethacrylate.

It is also preferred that the molar ratio of the hydrophilic group to hydrophobic group in the dispersant is 5:5-8:2.

The method of manufacturing vinyl chloride resin of the present invention facilitates the production of vinyl chloride resin having regular size distribution, excellent sphericity and proper particle diameter.

To achieve the second object of the present invention, the present invention provides a dispersant for manufacturing vinyl chloride resin, in which both a hydrophilic group and hydrophobic group are included, the molar ratio of the hydrophilic group to hydrophobic group is 5:5-8:2 and the hydrophilic group harbors one or more hydrophilic groups which are not a hydroxy group but might be C₃-C₇ carboxylic acid, C₂-C₉ sulfonic acid or C₂-C₉ hydroxy group.

The polydispersity index of the above dispersant is preferably 1.1-2.

The present invention is described in detail hereinafter.

The present invention provides a method of manufacturing vinyl chloride resin including the step of suspension polymerization after dispersing 100 weight part of vinyl chloride monomer; 0.01-1 weight part of a dispersant harboring a hydrophobic group and one or more hydrophilic groups not containing a hydroxy group and having a polydispersity index of 1.1-2; and 0.01-1 weight part of an initiator in a solvent.

As explained hereinbefore, a dispersant itself is a polymer which plays a role in dispersing various reactants including a monomer in a solvent as a droplet. The monomer and the solvent are formed in two phases and various reactants including a monomer are suspended in the solvent. At this time, a dispersant including both a hydrophilic group and a hydrophobic group reduces the surface tension of the droplet. The present inventors confirmed that the dispersant of the invention is very useful for manufacturing vinyl chloride resin with regular size distribution, excellent sphericity and proper diameter.

The hydrophilic group of the dispersant is preferably one of C₃-C₇ carboxylic acid, C₂-C₉ sulfonic acid or C₂-C₉ hydroxy group. Particularly, the carboxylic acid is selected from a group consisting of acrylic acid, methacrylic acid, itaconic acid and maleic anhydride. The sulfonic acid can be styrene sulfonic acid. The hydroxy group can be hydroxyethylacrylate, hydroxyethylmethacrylate or ethyleneglycolmonovinylether.

The hydrophobic group of the dispersant is selected from a group consisting of vinylacetate, ethylacetate, methylacrylate, ethylacrylate, 2-ethylhexylacrylate, butylmethacrylate, butylacrylate, methylmethacrylate and glycidylmethacrylate.

The carbon number of the hydrophobic group is preferably 4-9 but is not always limited thereto.

It is preferred that the molar ratio of the hydrophilic group to hydrophobic group in the dispersant is 5:5-8:2. When the hydrophilic group is less than the above ratio range, the activity as a protective colloid on the interface of water and vinyl chloride monomer is weakened, reducing significantly the stability of a particle. On the contrary, when the hydrophilic group is over the above ratio range of 8:2, the primary particles in vinyl chloride monomer droplets are easily aggregated, decreasing porosity.

The dispersant herein is prepared by the following processes; regulating the molar ratio of hydrophilic monomers to hydrophobic monomers to 5:5-8:2; mixing 100 weight part of the mixture of hydrophilic monomers and hydrophobic monomers with 0.01-1 weight part of an initiator and 0.01-5 weight part of a chain transfer agent; and polymerizing the reaction mixture by RAFT (reversible addition-fragmentation chain transfer polymerization).

The hydrophilic monomer used for preparing the dispersant is selected from a group consisting of C₃-C₇ carboxylic acid, C₂-C₉ sulfonic acid and C₂-C₉ alcohol. Particularly, the carboxylic acid is selected from a group consisting of acrylic acid, methacrylic acid, itaconic acid and maleic anhydride. The sulfonic acid can be styrene sulfonic acid. The alcohol can be hydroxyethylacrylate, hydroxyethylmethacrylate or ethyleneglycolmonovinylether.

The hydrophobic monomer used for preparing the dispersant can be selected from a group consisting of vinylacetate, ethylacetate, methylacrylate, ethylacrylate, 2-ethylhexylacrylate, butylmethacrylate, butylacrylate, methylmethacrylate and glycidylmethacrylate.

The initiator used for preparing the dispersant is selected from a group consisting of azobisdiisobutyronitrile (AIBN), benzoyl peroxide (BPO), methylethylketone peroxide, diacethyl peroxide, lauryl peroxide and tertiary butyl peroxide, but is not always limited thereto. The preferable content of the initiator in the dispersant is 0.01-1 weight part for the 100 weight part of the monomer. Less than 0.01 weight part of content of the initiator results in the decrease of polymerization speed thus prolonging the reaction time, so that the level of non-reacted monomers increases. On the contrary, more than 1 weight part of the initiator content causes the molecular weight to decrease and the molecular weight distribution to increase.

The chain transfer agent used for preparing the dispersant of the present invention is involved in the regulation of the molecular weight and molecular weight distribution of the dispersant according to the value of the shift constant. Also, a dithioester chain transfer agent can be used. The preferable content of the chain transfer agent in the dispersant is 0.01-5 weight part for 100 weight part of the monomer. Less than 0.01 weight part of the chain transfer agent content reduces the capability of regulating the molecular weight distribution. On the contrary, more than 5 weight part of the chain transfer agent content reduces the polymerization speed.

The polymerization of the dispersant is performed by RAFT (reversible addition-fragmentation chain transfer polymerization) at 40-100° C. for 4-48 hours. During RAFT the active species and propagating species interact with each other by reversible polymerization or depolymerization mediated by the chain transfer agent to grow continuously, suggesting a living property. Because of the living property, it produces a polymer with a narrow molecular weight distribution. It is also able to produce a block copolymer or a polymer with high molecular weight by adding a monomer.

The dispersant prepared by RAFT has a narrow molecular weight distribution and the early ratio of hydrophilic monomers to hydrophobic monomers is consistent with that of the final polymer.

The molecular weight distribution of the dispersant can be explained by the polydispersity index. The polydispersity index is obtained by dividing the weight average molecular weight of a polymer by the number mean molecular weight. The wider the molecular weight distribution, the higher the polydispersity index goes. The narrower the molecular weight distribution, the closer the polydispersity index is to 1. It is preferable that the polydispersity index of the dispersant of the invention be 1.1-2. A dispersant with a polydispersity index less than 1.1 is difficult to manufacture and a dispersant with a polydispersity index higher than 2 is not fully functional for preparing vinyl chloride resin.

The preferable content of the dispersant is 0.001-1 weight part for 100 weight part of vinyl chloride monomer. When the content of the dispersant is less than 0.01 weight part, the activity as a protective colloid on the interface of water and vinyl chloride decreases, causing a problem of over-sized particles. When the content of the dispersant is more than 1 weight part, the average diameter is smaller and the content of non-reacted molecules is higher.

Any conventional initiator available for radical polymerization can be used for manufacturing vinyl chloride resin, which is exemplified by AIBN, BPO, methylethylketone peroxide, diacetyl peroxide, lauryl peroxide and tertiary butyl peroxide, but is not always limited thereto. The preferable content of the initiator is 0.01-1 weight part for 100 weight part of vinyl chloride monomer. When the content of the initiator is less than 0.01 weight part, polymerization speed is reduced, making reaction time longer, and the content of non-reacted molecules is higher. When the content of the initiator is more than 1 weight part, the excessive initiator reduces thermo-stability and alters the color of the final resin product.

A solvent is used herein to disperse reactants rather than to dissolve them, and water can be used as a solvent but is not always limited thereto. Any liquid that is able to form two phases with a monomer to make a suspension can be utilized, for example de-ionized water, etc.

Suspension polymerization is preferably used for the polymerization of vinyl chloride resin. According to this method, impurities such as oxygen, etc, are eliminated from the reactor and a solvent, an initiator and a dispersant are added together and then vinyl chloride monomer is added thereto. The reaction temperature is raised. When it reaches a desired level, the temperature is maintained at the level and reaction is induced with stirring at regular speed to disperse the droplet properly.

Upon completion of the reaction, remaining non-reacted vinyl chloride is recovered. The resin product in the reactor is dried to give vinyl chloride resin.

The suspension polymerization above is one exemplary embodiment of the present invention, however this does not limit the spirit and scope of the present invention.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a photograph illustrating the particles of vinyl chloride resin prepared by the manufacturing method of the present invention in Example 3.

FIG. 2 is a photograph illustrating the particles of vinyl chloride resin prepared by the manufacturing method of the present invention in Example 4.

FIG. 3 is a photograph illustrating the particles of vinyl chloride resin prepared by the manufacturing method of the present invention in Comparative Example 1.

### BEST MODES FOR CARRYING OUT THE INVENTION

Practical and presently preferred embodiments of the present invention are illustrated as shown in the following examples.

However, it will be appreciated that those skilled in the art, on consideration of this disclosure, may make modifications and improvements within the spirit and scope of the present invention.

The physical properties of the vinyl chloride resin have been evaluated as follows.

Polydispersity Index

GPC (gel permeation chromatography) was performed with the prepared dispersant to evaluate the weight average molecular weight and the number mean molecular weight. After determining the ratio of the two, the polydispersity index was calculated. For GPC of the present invention, Waters HPLC (Waters) was used.

### EXAMPLE 1

### Preparation of a Dispersant by RAFT Polymerization

To a 3-neck flask were added 20 mL of methylmethacrylate, 0.027 g of the initiator N,N-azobisisobutyronitrile (AIBN) and 0.021 g of benzyl dithiobenzoate, then 50 ml of benzene was added thereto as a solvent. Reaction was induced at 60° C. for 4 hours in the presence of nitrogen. Upon completion of the reaction, the pressure was reduced and monomers and the solvent were evaporated.

The prepared polymethylmethacrylate was dissolved in 20 mL of dimethylformamide, to which 5 mL of acrylic acid and 0.015 g of AIBN were added, followed by reaction at 60° C. for 4 hours. Then, the solvent was evaporated to give a dispersant in the form of a block copolymer. The polydispersity index of the dispersant was 1.25.

### EXAMPLE 2

### Preparation of a Dispersant by RAFT Polymerization

To a 3-neck flask were added 20 mL of butylmethacrylate, 0.027 g of the initiator N,N-azobisisobutyronitrile (AIBN) and 0.021 g of benzyl dithiobenzoate, then 50 ml of benzene was added thereto as a solvent. Reaction was induced at 60° C. for 4 hours in the presence of nitrogen. Upon completion of the reaction, the pressure was reduced and monomers and the solvent were evaporated.

The prepared polymethylmethacrylate was dissolved in 20 mL of dimethylformamide, to which 5 mL of acrylic acid and 0.015 g of AIBN were added, followed by reaction at 60° C. for 4 hours. Then, the solvent was evaporated to give a dispersant in the form of a block copolymer. The polydispersity index of the dispersant was 1.88.

### EXAMPLE 3

### Preparation of Vinyl Chloride Resin Using the Dispersant Prepared in Example 1

To a 1000 liter reactor were added 130 weight part of de-ionized water, 0.06 weight part of the dispersant prepared in Example 1 and 0.06 weight part of the initiator bis(2-ethylhexyl)peroxydicarbonate for 100 weight part of vinyl chloride monomer together at the same time, followed by stirring in a vacuum. After adding vinyl chloride monomers, the reaction temperature was raised to 58° C., followed by polymerization. When the pressure of the reactor reached 7 kg/cm², the reactor was cooled down and non-reacted vinyl chloride monomers were recovered. The included water was eliminated and the product was dried.

### EXAMPLE 4

### Preparation of Vinyl Chloride Resin Using the Dispersant Prepared in Example 2

To a 1000 liter reactor were added 130 weight part of de-ionized water, 0.06 weight part of the dispersant prepared in Example 2 and 0.06 weight part of the initiator bis(2-ethylhexyl)peroxydicarbonate for 100 weight part of vinyl chloride monomer together at the same time, followed by stirring in a vacuum. After adding vinyl chloride monomers, the reaction temperature was raised to 58° C., followed by polymerization. When the pressure of the reactor reached 7 kg/cm², the reactor was cooled down and non-reacted vinyl chloride monomers were recovered. The included water was eliminated and the product was dried.

### COMPARATIVE EXAMPLE 1

### Preparation of Vinyl Chloride Resin Using Partially Saponified Vinyl Acetate Resin

To a 1000 liter reactor were added 130 weight part of de-ionized water, 0.06 weight part of a cellulose dispersant and 0.06 weight part of the initiator bis(2-ethylhexyl)peroxydicarbonate for 100 weight part of vinyl chloride monomer together at the same time, followed by stirring in a vacuum. After adding vinyl chloride monomers, the reaction temperature was raised to 58° C., followed by polymerization. When the pressure of the reactor reached 7 kg/cm², the reactor was cooled down and non-reacted vinyl chloride monomers were recovered. The included water was eliminated and the product was dried.

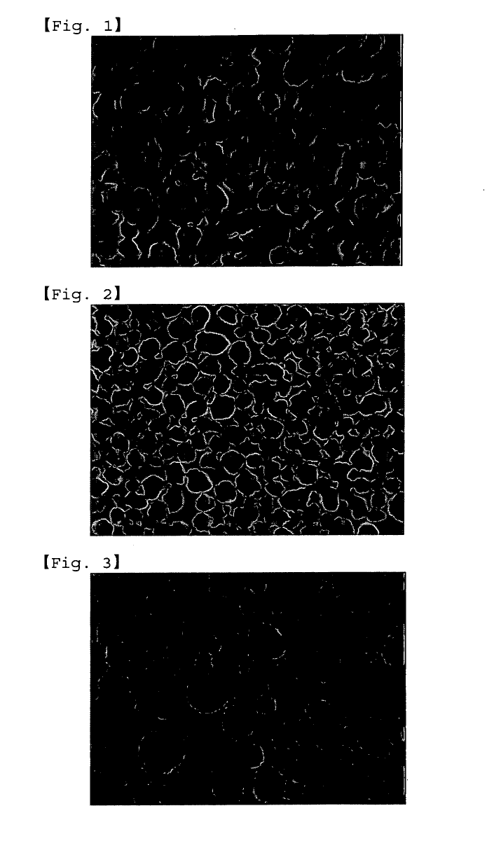

The vinyl chloride polymers prepared in Examples 3 and 4 and Comparative Example 1 were tested to determine the average diameter of particles and size distribution by using mastersizer (Malvern). The results are shown in Table 1. The vinyl chloride polymers prepared in Examples 3 and 4 and Comparative Example 1 were photographed, as shown in FIGS. 1, 2 and 3.

TABLE 1

| | | | Comparative |
|---|---|---|---|
| | Example 3 | Example 4 | Example 1 |
| Average diameter | 102 | 108 | 126 |
| (μm) | | | |
| Size | 0.63 | 0.59 | 0.82 |
| distribution | | | |

As shown in Table 1, the average diameter of vinyl chloride resin particles manufactured by using the dispersant of the present invention prepared by RAFT was a little smaller than that of the vinyl chloride resin of Comparative Example 1. From the result, it was presumed that the resins of Examples 3 and 4 might have better plasticity than the resin of Comparative Example 1.

The size distributions of the resins of Examples 3 and 4 were respectively 0.63 and 0.59, which are narrower than the size distribution of the resin of Comparative Example 1 (0.82), suggesting that the resins of Examples 3 and 4 have more regular distributions.

The size distributions of the resins of FIGS. 1 and 2 were observed to be very even, compared with that of FIG. 3.

### INDUSTRIAL APPLICABILITY

The dispersant for manufacturing vinyl chloride resin of the present invention and the method of manufacturing vinyl chloride resin using the dispersant of the present invention enables the preparation of vinyl chloride resin with even size distribution, excellent sphericity and proper particle diameter.

Those skilled in the art will appreciate that the conceptions and specific embodiments disclosed in the foregoing description may be readily utilized as a basis for modifying or designing other embodiments for carrying out the same purposes as the present invention. Those skilled in the art will also appreciate that such equivalent embodiments do not depart from the spirit and scope of the invention as set forth in the appended claims.

1. A method of manufacturing vinyl chloride resin including the step of suspension polymerization in which 100 weight part of vinyl chloride monomer; 0.01-1 weight part of a dispersant having a hydrophobic group and one or more hydrophilic groups not containing a hydroxy group, with a polydispersity index of 1.1-2; and 0.01-1 weight part of an initiator are dispersed in a solvent.

2. The method of manufacturing vinyl chloride resin according to claim 1, wherein the hydrophilic group is C₃-C₇ carboxylic acid or C₂-C₉ sulfonic acid.

3. The method of manufacturing vinyl chloride resin according to claim 2, wherein the carboxylic acid is selected from a group consisting of acrylic acid, methacrylic acid, itaconic acid and maleic anhydride.

4. The method of manufacturing vinyl chloride resin according to claim 2, wherein the sulfonic acid is styrene sulfonic acid.

5. The method of manufacturing vinyl chloride resin according to claim 1, wherein the hydrophobic monomer harboring a hydrophobic group is selected from a group consisting of vinylacetate, ethylacetate, methylacrylate, ethylacrylate, 2-ethylhexylacrylate, butylmethacrylate, butylacrylate, methylmethacrylate and glycidylmethacrylate.

6. The method of manufacturing vinyl chloride resin according to claim 1, wherein the molar ratio of the hydrophilic group to the hydrophobic group in the dispersant is 5:5-8:2.

7. The method of manufacturing vinyl chloride resin according to claim 1, wherein the dispersant is prepared by RAFT (reversible addition-fragmentation chain transfer polymerization) with 100 weight part of the monomer mixture of the hydrophilic monomers and hydrophobic monomers wherein the molar ratio of the hydrophilic group to the hydrophobic group is 5:5-8:2, 0.01-1 weight part of an initiator and 0.01-5 weight part of a chain transfer agent.

8. The method of manufacturing vinyl chloride resin according to claim 7, wherein the chain transfer agent is a dithioester.

9. The method of manufacturing vinyl chloride resin according to claim 7, wherein the polymerization of the dispersant is performed at 40-100° C.

10. A dispersant for manufacturing vinyl chloride resin, wherein a hydrophilic group and a hydrophobic group are included at the molar ratio of 5:5-8:2, and the hydrophilic group contains one or more hydrophilic groups but not a hydroxy group and is either C₃-C₇ carboxylic acid or C₂-C₉ sulfonic acid.

11. The dispersant for manufacturing vinyl chloride resin according to claim 10, wherein the polydispersity index of the dispersant for manufacturing vinyl chloride resin is 1.1-2.
